(19) United States
(12) Patent Application Publication
(10) Pub. No.: US 2022/0220362 A1
(43) Pub. Date: Jul. 14, 2022

(54) CHEMICAL FLUID CONTAINING AN ANTIOXIDANT FOR UNDERGROUND TREATMENT OF OIL AND GAS RESERVOIRS

(71) Applicants: NISSAN CHEMICAL CORPORATION, Tokyo (JP); NISSAN CHEMICAL AMERICA CORPORATION, Houston, TX (US)

(72) Inventors: Takahiro OHORI, Sodegaura-shi (JP); Hirotake KITAGAWA, Sodegaura-shi (JP); Satoru MURAKAMI, Sodegaura-shi (JP); Samuel MAGUIRE-BOYLE, Spring, TX (US); John SOUTHWELL, Glen Ellyn, IL (US)

(73) Assignees: NISSAN CHEMICAL CORPORATION, Tokyo (JP); NISSAN CHEMICAL AMERICA CORPORATION, Houston, TX (US)

(21) Appl. No.: 17/146,047

(22) Filed: Jan. 11, 2021

(51) Int. Cl. C09K 8/584; E21B 43/16

(52) U.S. Cl. CPC C09K 8/584; E21B 43/16

(57) ABSTRACT

A chemical fluid for underground injection includes an inorganic substance, an antioxidant (e.g. ascorbic acid, gluconic acid, or a salt thereof, or bisulfite, or disulfite), and water. The inorganic substance may be a colloidal particle or a powder. The inorganic substance may be present in the chemical fluid in amounts of 0.001% by mass to 50% by mass based on the total mass of the chemical fluid for underground injection. The antioxidant may be present in the chemical fluid at a ratio of 0.0001 to 2 of the mass of the antioxidant to the mass of the inorganic substance. A surface of the inorganic substance may be coated with a silane compound. The chemical fluid may further include an anionic surfactant, a cationic surfactant, an amphoteric surfactant, a nonionic surfactant, or a mixture thereof.

### BACKGROUND

### 1. Technical Field

The present application relates generally to a chemical fluid for the underground treatment of oil and gas containing reservoirs. Particularly, the present application relates to a chemical fluid for crude oil recovery having an excellent high-temperature salt tolerance and a high crude oil recovery rate as a chemical fluid for use in oil recovery flooding which recovers crude oil by injecting the chemical fluid into an oil reservoir of an inland or offshore oil field.

### 2. Description of the Related Art

Chemical fluids for underground injection have multiple applications for example, fluids which create seals to prevent water migration and fluids which create viscous gelled material upon injection into the reservoir, and chemical fluids for crude oil recovery for use in the primary, secondary, or tertiary recovery of petroleum.

A three-step method involving primary, secondary, and tertiary (also called enhanced oil recovery (EOR)) are applied to oil and gas reservoirs for recovering (collecting) crude oil from an oil reservoir.

Examples of primary recovery include natural flow from the reservoir which exploits the natural pressure of an oil reservoir, or gravity, and artificial lift which employs an artificial pressure through utilization of a pump. The crude oil recovery rate of the primary recovery that is carried out by these methods in combination is reportedly on the order of 20% oil recovery from the reservoir rock at the maximum. Examples of the secondary recovery method include water flooding and pressure maintenance which restores oil reservoir pressure and increases the amount of oil produced by introduction of water or gas after the oil production has declined from the primary recovery method. The crude oil recovery rate of these primary and secondary recovery methods together is reportedly on the order of 40%, which means that a great majority of crude oil remains in an underground oil reservoir. The tertiary recovery or EOR method utilizes some form of chemical flooding, and is proposed in order to further recover crude oil from the oil reservoir.

The EOR method includes thermal flooding, gas flooding, microbial flooding, chemical flooding, and the like of the oil reservoir. The chemical flooding technique involves pumping a chemical fluid suitable for a purpose into an oil reservoir to reduce the interfacial tension between the crude oil and a fluid so that the fluidity of crude oil itself is improved, thereby enhancing the collection efficiency of crude oil. The chemical flooding is classified according to the chemical fluid used into polymer flooding, surfactant flooding, micelle flooding, emulsion flooding, alkali flooding, and the like.

Surfactant flooding is EOR flooding which involves pumping a series of fluids including fluids composed mainly of surfactants into an oil reservoir to reduce the interfacial tension between crude oil and water, and allowing the crude oil trapped in the oil reservoir to flow to a producing well (see, for example, International Publication Nos. WO 2019/054414 and WO 2019/053907).
Patent literature 1: Publication No. WO 2019/054414
Patent literature 2: Publication No. WO 2019/053907

### SUMMARY

In one aspect of this application, a chemical fluid containing an inorganic substance, for example, very small colloidal particles of several nm to several tens of nm, such as colloidal silica, is used as a chemical fluid for underground injection, particularly, a chemical fluid for crude oil recovery. Such very small particles play a role in crude oil recovery by entering into fractures in rocks containing crude oil, and removing petroleum from rock surfaces.

For the chemical fluid for crude oil recovery for use in a crude oil recovery method using such a chemical fluid, surface water or seawater may be used in the preparation thereof. When the chemical fluid for crude oil recovery is used, i.e., when the chemical fluid is pumped into the oil reservoir, the chemical fluid comes into contact with formation water. The water that the fluid is in contact with frequently has high amounts of total dissolved solids (TDS) ranging from several tens of thousands of ppm to thirty five hundred thousand and several tens of thousands of ppm of different inorganic salts within the mass of total dissolved solids. The salts being contained in seawater, oil formation water, or terrestrial water. The chemical fluid for crude oil recovery, when prepared or when used, comes into contact with salt-containing water (also referred to as brine) having a salt concentration as high as a few hundred thousand ppm. For example, the salt concentration in the brine can be in the range of 0.1% by mass to 35% by mass, 1% to 20%, 2% to 15% by mass, 3% to 10%, or 4% to 8% by mass. If the chemical fluid for crude oil recovery upon contact with brine having a high salt concentration causes the inorganic substance (colloidal particles, etc.) contained in the chemical fluid to aggregate, or gelate, the chemical fluid becomes difficult to pump into the oil containing reservoir. Furthermore, the gel of the chemical fluid after pumping causes obstruction of fractures in the reservoir rock, making crude oil recovery difficult.

Hence, the chemical fluid for crude oil recovery is required to be stable at typical downhole temperatures even in the presence of brine having a high salt concentration, i.e., to maintain the stable dispersed state of the inorganic substance, for example, colloidal particles, contained in the chemical fluid without the gelation or aggregation of this inorganic substance, even when the chemical fluid comes into contact with and mixes with the brine to become a chemical fluid having a high salt concentration. The downhole temperatures encountered by the chemical fluid can typically be in the range of equal to or greater than 21° C., greater than 100° C., greater than 150° C., from 175 to 275° C., and from 200 to 250° C.

As described above, in the EOR technique of recovering crude oil by pumping a chemical fluid into the earth so that the inorganic substance, for example, colloidal particles in the chemical fluid enter into fractures in the reservoir rock containing crude oil and recovers the crude oil from the fractures in the reservoir rock. It is required for the free flow of the colloidal particles into the fractures in the reservoir rock that the inorganic substance, for example, the colloidal particles, should be stable without aggregation in the chemical fluid for crude oil recovery when exposed to high salt concentrations at typical downhole temperatures.

The present application provides a chemical fluid for underground injection, particularly, a chemical fluid for crude oil recovery, which is a chemical fluid containing an inorganic substance such as colloidal particles present in a stable dispersion even when the chemical fluid is exposed to a high salt concentration at typical downhole temperatures. The present application further provides a crude oil recovery method using the chemical fluid.

A first aspect of this disclosure is a chemical fluid for underground injection comprising an inorganic substance, an antioxidant, and water.

A second aspect of this disclosure is the chemical fluid for underground injection according to the first aspect, wherein the inorganic substance is a colloidal particle or a powder.

A third aspect of this disclosure is the chemical fluid for underground injection according to the first or second aspect, wherein the inorganic substance is at least one colloidal particle selected from the group consisting of a silica particle, an alumina particle, a titania particle, and a zirconia particle having an average particle diameter of 3 nm to 200 nm.

A fourth aspect of this disclosure is the chemical fluid for underground injection according to any one of the first to third aspects, wherein the inorganic substance is a silica particle in a silica sol of pH 1 to 12.

A fifth aspect of this disclosure is the chemical fluid for underground injection according to any one of the first to fourth aspects, wherein the inorganic substance is contained at a proportion of 0.001% by mass to 50% by mass based on the total mass of the chemical fluid for underground injection.

A sixth aspect of this disclosure is the chemical fluid for underground injection according to any one of the first to fifth aspects, wherein the antioxidant is hydroxylactone, hydroxycarboxylic acid, or a salt thereof, or sulfite.

A seventh aspect of this disclosure is the chemical fluid for underground injection according to any one of the first to fifth aspects, wherein the antioxidant is ascorbic acid, gluconic acid, or a salt thereof, or bisulfite, or disulfite.

An eighth aspect of this disclosure is the chemical fluid for underground injection according to any one of the first to seventh aspects, wherein the antioxidant is contained at a proportion of 0.0001 to 2 in terms of a mass ratio to the mass of the inorganic substance.

A ninth aspect of this disclosure is the chemical fluid for underground injection according to any one of the first to eighth aspects, wherein at least a portion of a surface of the inorganic substance is coated with a silane compound including hydrolyzable silane of Formula (1):

R¹ₐSi(R²)₄₋ₐ Formula (1)

wherein each R¹ is independently an epoxycyclohexyl group, a glycidoxyalkyl group, an oxetanylalkyl group, an organic group including any of the epoxycyclohexyl group, the glycidoxyalkyl group, or the oxetanylalkyl group, an alkyl group, an aryl group, an alkyl halide group, an aryl halide group, an alkoxyaryl group, an alkenyl group, an acyloxylalkyl group, or an organic group having an acryloyl group, a methacryloyl group, a mercapto group, an amino group, an amide group, a hydroxy group, an alkoxy group, an ester group, a sulfonyl group, or a cyano group, or a combination thereof and is bonded to the silicon atom through a Si—C bond,
R² is an alkoxy group, an acyloxy group, or a halogen atom,
a is an integer of 1 to 3.

A tenth aspect of this disclosure is the chemical fluid for underground injection according to the ninth aspect, wherein the silane compound is contained at a proportion of 0.1 to 10.0 in terms of a mass ratio to the mass of the inorganic substance.

An 11th aspect of this disclosure is the chemical fluid for underground injection according to any one of the first to tenth aspects, further comprising an anionic surfactant, a cationic surfactant, an amphoteric surfactant, a nonionic surfactant, or a mixture of two or more of these surfactants.

A 12th aspect of this disclosure is the chemical fluid for underground injection according to the 11th aspect, wherein the surfactant is contained at a proportion of 0.0001% by mass to 30% by mass based on the total mass of the chemical fluid for underground injection.

A 13th aspect of this disclosure is the chemical fluid for underground injection according to any one of the first to 12th aspects, wherein a ratio of Dynamic Light Scattering (DLS) average particle diameter after a room-temperature salt tolerance test/DLS average particle diameter before the test is 1.5 or less (a rate of change in average particle diameter is 50% or less), wherein the room-temperature salt tolerance test involves storing the chemical fluid for underground injection at 20° C. for 72 hours with a concentration of the inorganic substance set to a concentration of 0.1% by mass in an environment having a salt concentration of 4% by mass.

A 14th aspect of this disclosure is the chemical fluid for underground injection according to any one of the first to 12th aspects, wherein a ratio of DLS average particle diameter after a high-temperature salt tolerance test/DLS average particle diameter before the test is 1.5 or less (a rate of change in average particle diameter is 50% or less), wherein the high-temperature salt tolerance test involves storing the chemical fluid for underground injection at 100° C. for 720 hours with a concentration of the inorganic substance set to a concentration of 0.1% by mass in an environment having a salt concentration of 4% by mass.

A 15th aspect of this disclosure is the chemical fluid for underground injection according to any one of the first to 14th aspects, wherein the chemical fluid for underground injection is a chemical fluid for crude oil recovery which is used for recovering crude oil from an underground hydrocarbon-containing reservoir and pumped into an underground reservoir from an injection well to recover the crude oil from a production well.

A 16th aspect of this disclosure is the chemical fluid for underground injection according to the 15th aspect, wherein the chemical fluid for underground injection is a chemical fluid for crude oil recovery containing 0.1% by mass to 35% by mass of a salt based on the total mass of the chemical fluid.

A 17th aspect of this disclosure is a method for recovering crude oil from an underground hydrocarbon-containing reservoir, the method comprising the steps of:

(a) pumping the chemical fluid for underground injection according to any one of the first to 16th aspects into an underground reservoir from an injection well; and
(b) recovering crude oil from a production well, together with the chemical fluid pumped into the underground reservoir.

In embodiments, the chemical fluid for underground injection, particularly, the chemical fluid for crude oil recovery, described herein is a stable chemical fluid where the inorganic substance (e.g., colloidal particles) does not form a gel, even when in contact with a salt contained in water such as surface water or seawater at the time of preparation of the chemical fluid or a salt at the time of injection into an oil reservoir of an inland or offshore oil field. Particularly, the stable colloidal particle present in the chemical fluid for underground injection can be expected to further improve the effect of recovering crude oil from the reservoir rock surface by the wedge effect of a colloidal substance (e.g., silica nanoparticles), when the chemical fluid is pumped into fractures in rocks containing crude oil. Hence, this chemical fluid for underground injection can be useful as a chemical fluid for crude oil recovery that can be expected to recover crude oil with a high recovery rate.

### DETAILED DESCRIPTION OF THE EMBODIMENTS

The present application provides a chemical fluid for underground injection comprising an inorganic substance, an antioxidant, and water.

[Inorganic Substance]

The inorganic substance can be used in the form of a colloidal particle or a powder.

The inorganic substance can be contained in the chemical fluid at a proportion of 0.001% by mass to 50% by mass based on the total mass of the chemical fluid for underground injection.

An inorganic powder of inorganic oxide, such as a silica powder, an alumina powder, a titania powder, or a zirconia powder having a particle diameter of larger than 200 nm and 3 microns or smaller can be used as the inorganic substance. The inorganic powder can be any powder containing an inorganic oxide component such as a silica component, an alumina component, a titania component, or a zirconia component, and both synthetic and natural products can be used. Specific examples of the inorganic powder include silica-containing powders such as quartz powder and quartz sand powder, and alumina-containing powders such as mullite and alumina. The particle size of these inorganic substances can be measured by a laser diffraction method.

When the inorganic substance is a colloidal particle, a colloidal particle of inorganic oxide, such as a silica particle, an alumina particle, a titania particle, or a zirconia particle having an average particle diameter of 3 nm to 200 nm, 3 nm to 100 nm, or 3 nm to 50 nm can be used. These colloidal particles can be used in the form of an aqueous sol such as a silica sol, an alumina sol, a titania sol, or a zirconia sol.

Preferably, a silica particle based on a silica sol of pH 1 to 12 can be used as the inorganic substance.

In the case of using an inorganic substance, for example, a silica particle, an aqueous silica sol can be used.

The aqueous silica sol refers to a colloidal dispersion system containing an aqueous solvent as a dispersion medium and colloidal silica particles as a dispersoid, and can be produced by any known method in the art.

The average particle diameter of the aqueous silica sol refers to the average particle diameter of the colloidal silica particles serving as a dispersoid.

The average particle diameter of the inorganic substance, for example, the aqueous silica sol (colloidal silica particles), refers to a specific surface area diameter obtained by measurement according to a nitrogen adsorption method (BET method), or a Sears method particle diameter, unless otherwise specified.

The specific surface area diameter obtained by measurement according to a nitrogen adsorption method (BET method) (average particle diameter (specific surface area diameter) D (nm)) is given according to the expression D (nm)=2720/S from specific surface area S (m²/g) measured by the nitrogen adsorption method.

The Sears method particle diameter refers to an average particle diameter measured on the basis of the literature: G. W. Sears, Anal. Chem. 28 (12), p. 1981, 1956, a rapid method for measuring a colloidal silica particle diameter. Specifically, the specific surface area of colloidal silica is determined from the amount of 0.1 N NaOH required for titrating colloidal silica corresponding to 1.5 g of SiO₂ from pH 4 to pH 9, and an equivalent diameter (specific surface area diameter) calculated therefrom is used.

The average particle diameter of the inorganic substance, for example, the aqueous silica sol (colloidal silica particles), based on the nitrogen adsorption method (BET method) or the Sears method can be 3 to 200 nm, 3 to 150 nm, 3 to 100 nm, or 3 to 30 nm.

If the average particle diameter of the inorganic substance (e.g., colloidal silica particles) is smaller than 3 nm, the chemical fluid might be unstable, which is not preferred. On the other hand, if the average particle diameter of the inorganic substance (e.g., colloidal silica particles) is larger than 200 nm, the pore space of sand stones or carbonate rocks present in a strata of an underground oil field reservoir might be blocked, leading to poor oil recoverability, which is not preferred.

The dispersed state (whether to be in a dispersed state or in an aggregated state), together with the average particle diameter DLS average particle diameter, of the inorganic substance (e.g., silica particles of a silica sol) in the chemical fluid can be determined by the DLS measurement.

The DLS average particle diameter refers to an average value of secondary particle diameters (dispersed particle diameters). The DLS average particle diameter in a completely dispersed state is reportedly about twice the average particle diameter (which is a specific surface area diameter obtained by measurement according to the nitrogen adsorption Brunauer-Emmett-Teller (BET) method or the Sears method, and refers to an average value of primary particle diameters). From a larger DLS average particle diameter, a more aggregated state of the inorganic substance (e.g., silica particles in an aqueous silica sol) can be determined.

One example of the inorganic substance, particularly, the aqueous silica sol, can include aqueous silica sol SNOWTEX (registered trademark (R)) ST-O manufactured by Nissan Chemical Corp. This aqueous silica sol has an average particle diameter of 10 to 11 nm via BET method and an average particle diameter of 15 to 20 nm via DLS method. As shown in Examples mentioned later, a chemical fluid for crude oil recovery containing this aqueous silica sol and its salt tolerance evaluation sample (chemical fluid containing a salt) have a DLS average particle diameter of substantially 30 nm or smaller, e.g., in an exemplary range of 15 nm to 25 nm. This result indicates that the silica particles are in a substantially dispersed state in the chemical fluid and in the chemical fluid containing a salt.

In the case of using a silica particle as the inorganic substance, a commercially available product can be used as the aqueous silica sol. An aqueous silica sol having a silica concentration of 5 to 50% by mass is generally commercially available and is preferred because this product can be readily obtained.

Examples of the commercially available product of the aqueous silica sol include SNOWTEX® ST-OXS, SNOWTEX® ST-OS, SNOWTEX® ST-O, SNOWTEX® ST-O-40, SNOWTEX® ST-OL, SNOWTEX® ST-OYL, and SNOWTEX® ST-OZL-35 (all manufactured by Nissan Chemical Corp.).

The silica (SiO₂) concentration of the aqueous silica sol used is preferably, for example, 5 to 55% by mass.

The inorganic substance (in the case of, for example, an aqueous silica sol, in terms of a silica solid content) can be contained in the chemical fluid at 0.001% by mass to 50% by mass or 0.01% by mass to 30.0% by mass, more preferably 10.0% by mass to 25.0% by mass, for example, 15.0% by mass to 25.0% by mass, based on the total mass of the chemical fluid for underground injection, for example, a chemical fluid for crude oil recovery.

At least a portion of the surface of the inorganic substance (e.g., at least a portion of the surface of the silica particle when the silica particle in the aqueous silica sol is taken as an example) can be coated with a silane compound mentioned later.

In this disclosure, the phrase “at least a portion of a surface of the inorganic substance is coated with a silane compound” refers to a form in which the silane compound is bound with at least a portion of the surface of the inorganic substance (e.g., the silica particle). Specifically, this phrase encompasses a form in which the silane compound covers the whole surface of the inorganic substance, a form in which the silane compound covers a portion of the surface of the inorganic substance, and a form in which the silane compound is bound with the surface of the inorganic substance.

The particle diameter of the silica particle in the aqueous silica sol, at least a portion of the surface of which is bound with the silane compound may be readily measured as the DLS particle diameter mentioned above using a commercially available apparatus.

At least a portion of the surface of the inorganic substance (e.g., the silica particle) for use in the chemical fluid for underground injection of the present invention may be coated with a silane compound including hydrolyzable silane of Formula (1) given below.

A silanol group formed by the hydrolysis of the hydrolyzable silane of the Formula (1) given below reacts with a silanol group present on the surface of the inorganic substance, for example, the silica particle, to bind the silane compound of Formula (1) to the surface of the silica particle.

R¹ₐSi(R²)₄₋ₐ Formula (1)

In Formula (1), each R¹ is independently an epoxycyclohexyl group, a glycidoxyalkyl group, an oxetanylalkyl group, an organic group including any of the epoxycyclohexyl group, the glycidoxyalkyl group, or the oxetanylalkyl group, an alkyl group, an aryl group, an alkyl halide group, an aryl halide group, an alkoxyaryl group, an alkenyl group, an acyloxylalkyl group, or an organic group having an acryloyl group, a methacryloyl group, a mercapto group, an amino group, an amide group, a hydroxyl group, an alkoxy group, an ester group, a sulfonyl group, or a cyano group, or a combination thereof and is bonded to the silicon atom through a Si—C bond,

R² is an alkoxy group, an acyloxy group, or a halogen atom, and

a is an integer of 1 to 3.

In some embodiments, the hydrolyzable silane may be represented by Formula (1-1):

R^{x}_{c}R^{Y}_{d}Si(R^{z})_{4-(c+d)} Formula (1-1).

In Formula (1-1), R^{x} is an epoxycyclohexyl group, a glycidoxyalkyl group, or an organic group including any of these groups and is bonded to the silicon atom through a Si—C bond,

R^{y} is an alkyl group, an aryl group, an alkyl halide group, an aryl halide group, an alkoxyaryl group, an alkenyl group, an acyloxylalkyl group, or an organic group having an acryloyl group, a methacryloyl group, a mercapto group, an amino group, an amide group, a hydroxyl group, an alkoxy group, an ester group, a sulfonyl group, or a cyano group, or a combination thereof and is bonded to the silicon atom through a Si—C bond,

R^{z} is an alkoxy group, an acyloxy group, or a halogen atom, and

c is an integer of 1, d is an integer of 0 to 2, and c+d is an integer of 1 to 3.

The silane compound of Formula (1) can have an epoxycyclohexyl group, a glycidoxyalkyl group, or an organic group including any of these groups.

Examples of the silane compound of Formula (1) include 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-(3,4-epoxycyclohexyl)propyltrimethoxysilane, 3-(3,4-epoxycyclohexyl)propyltriethoxysilane, 2-(3,4-epoxycyclohexyl)ethyltrimethoxysilane, 2-(3,4-epoxycyclohexyl)ethyltriethoxysilane, 1-(3,4-epoxycyclohexyl)methyltrimethoxysilane, and 1-(3,4-epoxycyclohexyl)methyltriethoxysilane.

Examples of a silane compound having an oxetane ring include [(3-ethyl-3-oxetanyl)methoxy]propyltrimethoxysilane, and [(3-ethyl-3-oxetanyl)methoxy]propyltriethoxysilane.

In the chemical fluid for underground injection of this disclosure, the silane compound is preferably added at a proportion of silane compound/inorganic substance (e.g., the aqueous silica sol (silica: SiO₂))=0.1 to 10.0 in terms of a mass ratio to the inorganic substance (e.g., the silica solid content, i.e., the silica particle, in the aqueous silica sol). More preferably, the silane compound is added such that the mass ratio is 0.1 to 5.0.

Thus, in some embodiments, a portion of the surface of the inorganic substance (the silica particle in the aqueous silica sol) mentioned above may be bound with at least a portion of the silane compound. For example, the silica particle, at least a portion of the surface of which is bound with the silane compound also includes a silica particle surface-coated with the silane compound. Use of the silica particle, at least a portion of the surface of which is bound with the silane compound, for example, the silica particle surface-coated with the silane compound, can further improve the high-temperature salt tolerance of the chemical fluid for crude oil recovery.

Thus, in some aspects, the chemical fluid for underground injection comprises an inorganic substance (silica particle) prepared by binding at least a portion of the silane compound to at least a portion of the surface of the inorganic substance (silica particle in the aqueous silica sol).

[Antioxidant]

The chemical fluid includes an antioxidant. Hydroxylactone, hydroxycarboxylic acid, or a salt thereof, or sulfite can be used as the antioxidant. In addition or alternatively, ascorbic acid, gluconic acid, or a salt thereof, or bisulfite, or disulfite can be used as the antioxidant. Likewise, any combinations of the foregoing can be used as the antioxidant.

Ascorbic acid or gluconic acid can be used as ascorbic acid salt or gluconic acid salt depending on the pH of the chemical fluid for underground injection. Sodium ascorbate, potassium ascorbate, calcium ascorbate, magnesium ascorbate, ascorbic acid amine salt, or the like can be used as the ascorbic acid salt. Sodium gluconate, calcium gluconate, magnesium gluconate, gluconic acid amine salt, or the like can be used as the gluconic acid salt.

In some aspects, L and D optical isomers of ascorbic acid can be present in the chemical fluid, so that both the forms of ascorbic acid are used as an antioxidant for underground treatment techniques described herein. Both isomers can provide antioxidant capability.

L and D optical isomers of other ones of the above organic molecules can also provide the antioxidant capabilities and thus can be used in the chemical fluid, including L and D optical isomers of the lactone antioxidants.

In some aspects, sodium salt or potassium salt can be used as the disulfite or the bisulfite antioxidant. Examples thereof can include sodium disulfite, potassium disulfite, sodium bisulfite, and potassium bisulfite.

The antioxidant can be contained at a proportion of 0.0001 to 2 in terms of a mass ratio to the inorganic substance.

[Surfactant]

In some embodiments, the chemical fluid for underground injection can comprise a surfactant.

The surfactant can be contained at a proportion of 0.0001% by mass to 30% by mass based on the total mass of the chemical fluid for underground injection.

The surfactant can be an anionic surfactant, a cationic surfactant, an amphoteric surfactant, a nonionic surfactant, or a mixtures thereof. Additionally, two or more anionic surfactants and one or more nonionic surfactants can be used in combination as the surfactant.

Examples of the anionic surfactant include sodium salt and potassium salt of fatty acid, alkylbenzenesulfonic acid salt, higher alcohol sulfuric acid ester salt, polyoxyethylene alkyl ether sulfate, α-sulfo fatty acid ester salt, α-olefinsulfonic acid salt, monoalkylphosphoric acid ester salt, and alkanesulfonic acid salt.

Examples of the alkylbenzenesulfonic acid salt include sodium salt, potassium salt, and lithium salt including sodium C₁₀₋₁₆ alkylbenzenesulfonate, potassium C₁₀₋₁₆ alkylbenzenesulfonate, and sodium alkylnaphthalenesulfonate.

Examples of the higher alcohol sulfuric acid ester salt include C₁₂ sodium dodecyl sulfate (sodium lauryl sulfate), triethanolamine lauryl sulfate, and triethanol ammonium lauryl sulfate.

Examples of the polyoxyethylene alkyl ether sulfate include sodium polyoxyethylene styrenated phenyl ether sulfate, ammonium polyoxyethylene styrenated phenyl ether sulfate, sodium polyoxyethylene decyl ether sulfate, ammonium polyoxyethylene decyl ether sulfate, sodium polyoxyethylene lauryl ether sulfate, ammonium polyoxyethylene lauryl ether sulfate, sodium polyoxyethylene tridecyl ether sulfate, and sodium polyoxyethylene oleyl cetyl ether sulfate.

Examples of the α-olefinsulfonic acid salt include sodium α-olefinsulfonate.

Examples of the alkanesulfonic acid salt include sodium 2-ethylhexylsulfate.

In the case of using an anionic surfactant, the anionic surfactant is preferably contained at a proportion of 0.001% by mass to 30% by mass or 0.001% by mass to 20% by mass in based on the total mass of the chemical fluid for underground injection (e.g., a chemical fluid for crude oil recovery). If the content is less than 0.001% by mass, the chemical fluid has poor high-temperature salt tolerance and ability to recover crude oil, which is not preferred. If the content is more than 30% by mass and furthermore, more than 20% by mass, recovered oil is vigorously emulsified with the surfactant and is thus difficult to separate from the surfactant, which is not preferred.

In some aspects, an optimum application of the chemical fluid for underground injection can be selected, as described later, depending on its pH value of 7 or higher and lower than 12 or its pH value of 2 or higher and lower than 7. In this respect, the chemical fluid can have much better high-temperature salt tolerance by adjusting the amount of the anionic surfactant.

In the case of adjusting the pH of the chemical fluid for underground injection to, for example, 7 or higher and lower than 12, the anionic surfactant is preferably contained in an amount of 0.4 or more and less than 5.0 in terms of a mass ratio to the silica solid content of the chemical fluid for underground injection.

In the case of adjusting the pH of the chemical fluid for underground injection to 2 or higher and lower than 7, the anionic surfactant is preferably contained in an amount of 0.001 or more and less than 0.4 in terms of a mass ratio to the silica solid content of the chemical fluid for underground injection.

Examples of the cationic surfactant include alkyl trimethylammonium salt, dialkyl dimethylammonium salt, alkyl dimethylbenzylammonium salt, and N-methyl bishydroxyethylamine fatty acid ester hydrochloride.

Examples of the alkyl trimethylammonium salt include dodecyl trimethylammonium chloride, cetyl trimethylammonium chloride, coco-alkyl trimethylammonium chloride, alkyl (C₁₆₋₁₈) trimethylammonium chloride, and behenyl trimethylammonium chloride.

Examples of the dialkyl dimethylammonium salt include didecyl dimethylammonium chloride, di-coco-alkyl dimethylammonium chloride, di-hydrogenated tallow alkyl dimethylammonium chloride, dialkyl (C₁₄₋₁₈) dimethylammonium chloride, and dioleyl dimethylammonium chloride.

Examples of the alkyl dimethylbenzylammonium salt include alkyl (C₈₋₁₈) dimethylbenzylammonium chloride.

In the case of using a cationic surfactant, the cationic surfactant is preferably contained at a proportion of 0.001% by mass to 30% by mass based on the total mass of the chemical fluid for underground injection. If the content is less than 0.001% by mass, the chemical fluid might have poor heat resistance and salt tolerance, which is not preferred. If the content is more than 30% by mass, the chemical fluid might have very high viscosity, which is not preferred.

Examples of the amphoteric surfactant include alkylamino fatty acid salt, alkyl betaine, and alkylamine oxide.

Examples of the alkylamino fatty acid salt include cocamidopropyl betaine and lauramidopropyl betaine.

Examples of the alkyl betaine include lauryl dimethylaminoacetic acid betaine, myristyl betaine, stearyl betaine, and lauramidopropyl betaine.

Examples of the alkylamine oxide include lauryl dimethylamine oxide.

In the case of using an amphoteric surfactant, the amphoteric surfactant is preferably contained at a proportion of 0.001% by mass to 30% by mass based on the total mass of the chemical fluid for underground injection. If the content is less than 0.001% by mass, the chemical fluid might have poor heat resistance and salt tolerance, which is not preferred. If the content is more than 30% by mass, the chemical fluid might have a very high viscosity, which is not preferred.

The nonionic surfactant is selected from polyoxyethylene alkyl ether, polyoxyethylene alkyl phenyl ether, alkyl glucoside, polyoxyethylene fatty acid ester, sucrose fatty acid ester, sorbitan fatty acid ester, polyoxyethylene sorbitan fatty acid ester, and fatty acid alkanolamide.

Examples of the polyoxyethylene alkyl ether include polyoxyethylene dodecyl ether (polyoxyethylene lauryl ether), polyoxyalkylene lauryl ether, polyoxyethylene tridecyl ether, polyoxyalkylene tridecyl ether, polyoxyethylene myristyl ether, polyoxyethylene cetyl ether, polyoxyethylene oleyl ether, polyoxyethylene stearyl ether, polyoxyethylene behenyl ether, polyoxyethylene-2-ethyl hexyl ether, and polyoxyethylene isodecyl ether.

Examples of the polyoxyethylene alkyl phenyl ether include polyoxyethylene styrenated phenyl ether, polyoxyethylene nonyl phenyl ether, polyoxyethylene distyrenated phenyl ether, and polyoxyethylene tribenzyl phenyl ether.

Examples of the alkyl glucoside include decyl glucoside and lauryl glucoside.

Examples of the polyoxyethylene fatty acid ester include polyoxyethylene monolaurate, polyoxyethylene monostearate, polyoxyethylene monooleate, polyethylene glycol distearate, polyethylene glycol dioleate, and polypropylene glycol dioleate.

Examples of the sorbitan fatty acid ester include sorbitan monocaprylate, sorbitan monolaurate, sorbitan monomyristate, sorbitan monopalmitate, sorbitan monostearate, sorbitan distearate, sorbitan tristearate, sorbitan monooleate, sorbitan trioleate, sorbitan monosesquioleate, and their ethylene oxide adducts.

Examples of the polyoxyethylene sorbitan fatty acid ester include polyoxyethylene sorbitan monolaurate, polyoxyethylene sorbitan monopalmitate, polyoxyethylene sorbitan monostearate, polyoxyethylene sorbitan tri stearate, polyoxyethylene sorbitan monooleate, polyoxyethylene sorbitan trioleate, and polyoxyethylene sorbitan triisostearate.

Examples of the fatty acid alkanolamide include coconut oil fatty acid diethanolamide, tallow fatty acid diethanolamide, lauric acid diethanolamide, and oleic acid diethanolamide.

In addition, polyoxy alkyl ether or polyoxy alkyl glycol such as polyoxyethylene polyoxypropylene glycol or polyoxyethylene fatty acid ester, polyoxyethylene hydrogenated castor oil ether, sorbitan fatty acid ester alkyl ether, alkyl polyglucoside, sorbitan monooleate, sucrose fatty acid ester, or the like may be used.

Among these nonionic surfactants, polyoxyethylene alkyl ether or polyoxyethylene alkyl phenyl ether is more preferred because of favorable high-temperature salt tolerance of the chemical fluid.

In the case of using a nonionic surfactant, the nonionic surfactant is preferably contained at a proportion of 0.0001% by mass to 30% by mass based on the total mass of the chemical fluid for underground injection. If the content is less than 0.0001% by mass, the chemical fluid might have poor heat resistance and salt tolerance, which is not preferred. If the content is more than 30% by mass, the chemical fluid might haves very high viscosity, which is not preferred.

[Other Components]

The chemical fluid for underground injection of this disclosure can be further supplemented with other standard oilfield components such as hydroxyethylcellulose and its salts, hydroxypropylmethylcellulose and its salts, carboxymethylcellulose and its salts, pectin, guar gum, xanthan gum, tamarind gum, and carrageenan as water-soluble polymers, polyacrylamides and other polyacrylamide derivatives in order to enhance the viscosity and fluid dynamics of the chemical fluid downhole.

[Production of Chemical Fluid for Underground Injection]

The chemical fluid can be produced by mixing the inorganic substance, the antioxidant (e.g., ascorbic acid or its salt), and water. If necessary, other components can be appropriately further added thereto.

Before being pumped downhole or while being pumped downhole also called “on-the-fly”, the chemical fluid for underground injection can be diluted on the order of 1:1- to 4000-fold with the available water which may be for example surface water or seawater, and can be pumped into the targeted stratum.

[pH and Application]

In some aspects, the optimum application of the chemical fluid for underground injection can be selected depending on its pH value of 7 or higher and lower than 12 or its pH value of 2 or higher and lower than 7.

The chemical fluid for underground injection having a pH value of 7 or higher and lower than 12 can exhibit excellent high-temperature salt tolerance in the presence of brine containing a chloride ion and a sodium ion, a calcium ion, a magnesium ion, or the like (e.g., use for an inland underground oil reservoir is assumed).

The chemical fluid for underground injection having a pH value of 2 or higher and lower than 7 can exhibit excellent high-temperature salt tolerance in the presence of brine containing a chloride ion and a sodium ion, a calcium ion, a magnesium ion, or the like as well as seawater (e.g., use for an offshore oil reservoir of an offshore oil field is assumed).

In some aspects, the chemical fluid for underground injection described herein can obtain excellent high-temperature salt tolerance even if its pH value is adjusted to 12 using an aqueous alkali metal solution such as sodium hydroxide or potassium hydroxide, ammonium hydroxide, a basic aqueous amine solution, or the like.

[Salt Tolerance Evaluation]

The chemical fluid for underground injection can be evaluated for its salt tolerance (stability in brine) by a salt tolerance test which involves storing the chemical fluid in an environment containing a salt. When change in the average particle diameter of the inorganic substance measured by DLS has a narrow size distribution when measured before and after this test, the inorganic substance can be evaluated as maintaining a dispersed state. Thus, the chemical fluid can be evaluated as having favorable salt tolerance. On the other hand, when the DLS average particle diameter of the inorganic substance is largely increased after the salt tolerance test, this reflects the aggregated state of the inorganic substance. Thus, the chemical fluid can be evaluated as being inferior in salt tolerance.

For example, in order to evaluate salt tolerance at room temperature, the chemical fluid for underground injection can be evaluated for its salt tolerance (stability in brine) at room temperature by a room-temperature salt tolerance test which involves storing the chemical fluid at 20° C. for 72 hours with a concentration of the inorganic substance set to a concentration of 0.1% by mass in an environment having a salt concentration of 4% by mass.

When the ratio of the DLS average particle diameter after the room-temperature salt tolerance test/the DLS average particle diameter before the test is 8.0 or less, 1.5 or less (a rate of change in average particle diameter is 50% or less), or 1.1 or less (a rate of change in average particle diameter is 10% or less), the inorganic substance can be evaluated as maintaining a dispersed state in the chemical fluid without aggregation or gelation after the room-temperature salt tolerance test.

The chemical fluid for underground injection can be evaluated for its salt tolerance at a high temperature by a high-temperature salt tolerance test which involves storing the chemical fluid at 100° C. for 720 hours with a concentration of the inorganic substance set to a concentration of 0.1% by mass in an environment having a salt concentration of 4% by mass.

When the ratio of the DLS average particle diameter after the high-temperature salt tolerance test/the DLS average particle diameter before the test is 8.0 or less, 1.5 or less, or 1.1 or less, the inorganic substance can be evaluated as maintaining a dispersed state in the chemical fluid without aggregation or gelation after the high-temperature salt tolerance test. However, if the chemical fluid has poor high-temperature salt tolerance, the DLS particle diameter after the high-temperature salt tolerance test is very large, indicating the aggregated state of the inorganic substance in the chemical fluid.

For example, the chemical fluid can be determined, by the high-temperature salt tolerance test (e.g., storage at 100° C. for 720 hours) described above, to have favorable salt tolerance when the ratio of the DLS average particle diameter after the high-temperature salt tolerance test/the average particle diameter before the test is 1.5 or less (a rate of change in average particle diameter is 50% or less). Particularly, a chemical fluid having this ratio of 1.1 or less (a rate of change in average particle diameter is 10% or less) can be determined to have excellent high-temperature salt tolerance without the degeneration of the inorganic substance (e.g., a silica sol).

[Crude Oil Recovery Method]

The chemical fluid for underground injection can be used for recovering crude oil from an underground hydrocarbon-containing reservoir and is useful as a chemical fluid for crude oil recovery which is pumped into an underground reservoir from an injection well to recover the crude oil from a production well.

When water used in the preparation of the chemical fluid for crude oil recovery is surface water or seawater, the chemical fluid is exposed to a salt contained therein. In these embodiments, the chemical fluid can contain, for example, 0.1% by mass to 35% by mass of a salt, 1% to 20%, 3% to 17%, 5% to 15%, or 7% to 12%, based on the total mass of the chemical fluid. Also, the chemical fluid for crude oil recovery, when used, i.e., when entering into the earth, comes into contact with a salt in formation water or terrestrial water and is exposed to a high concentration of the salt.

For example, seawater, formation water, or terrestrial water can contain 0.1% by mass to 35% by mass of a salt, or from 1 to 20%, 2 to 15%, 3 to 10%, or 4 to 8%. Therefore, the inorganic substance, for example, colloidal particles, in the chemical fluid is required to be stably dispersed even in brine having such a high salt concentration.

The chemical fluid for underground injection of the present invention is used in a method for recovering crude oil from an underground hydrocarbon-containing reservoir. Specifically, a crude oil recovery method can be performed which comprises the steps of:

(a) pumping the chemical fluid for underground injection into an underground reservoir from an injection well; and
(b) recovering crude oil from a production well, together with the chemical fluid pumped into the underground reservoir.

### EXAMPLES

Aspects of the invention are described in more detail with reference to Synthesis Examples, Examples, and Comparative Examples. However, the present invention is not limited by these examples by any means.

(Measurement Apparatus)

The analysis (pH value, electric conductivity, and DLS average particle diameter) of aqueous silica sols prepared in Synthesis Examples as well as the analysis (pH value, electric conductivity, viscosity, and DLS average particle diameter) of chemical fluids produced in Examples and Comparative Examples and the analysis of samples after a room-temperature salt tolerance test or a high-temperature salt tolerance test of samples prepared using the chemical fluids were conducted using the following apparatuses.

DLS average particle diameter (dynamic light scattering particle diameter): Dynamic light scattering particle diameter measurement apparatus Zetasizer Nano (manufactured by Malvern Panalytical Ltd./Spectris Co, Ltd.) was used.
pH: pH meter (manufactured by DKK-Toa Corp.) was used.
Electric conductivity: Electric conductivity meter (manufactured by DKK-Toa Corp.) was used.
Viscosity: Type B viscometer (manufactured by Tokyo Keiki Inc.) was used.
Interfacial tension: Surface tensiometer DY-500 (manufactured by Kyowa Interface Science Co., Ltd.) was used.

[Evaluation of Chemical Fluid for Crude Oil Recovery]

(Salt Tolerance Evaluation)

<Preparation of Brine Test Sample>

A stirring bar was placed in a 200 ml styrol bottle, which was then charged with 0.83 g of a chemical fluid produced in each Example or Comparative Example, and stirred with a magnet stirrer. While stirred with a magnet stirrer, the bottle was charged with 49.2 g of pure water and 100 g of a brine solution having a salt concentration of 6% by mass, and stirred for 1 hour. The resultant was used as a brine test sample for evaluating the chemical fluid for its heat resistance and salt tolerance with a silica concentration set to a concentration of 0.1% by mass under a salt concentration of 4% by mass. The obtained brine test sample was evaluated for its pH, electric conductivity, viscosity, and DLS average particle diameter of an aqueous silica sol (silica particle) in the sample.

<Room-Temperature Salt Tolerance Evaluation>

In a hermetically sealable 200 ml styrol container, 150 g of the brine test sample was placed. After being hermetically sealed, the styrol container was left standing at 20° C. and kept for a predetermined time. Then, the brine test sample was evaluated for its appearance, pH, electric conductivity, and DLS average particle diameter of an aqueous silica sol (silica particle) in the sample.

The salt tolerance was evaluated according to the assessment of salt tolerance (refer to following “Assessment of salt tolerance”) on the basis of results of measuring the DLS average particle diameter of an aqueous silica sol (silica particle) in the sample kept at 20° C. for a predetermined time (after 72 hours) and according to the appearance.

<Assessment of Salt Tolerance>

A: The ratio of the DLS average particle diameter after the salt tolerance test/the DLS average particle diameter before the test is 1.1 or less.
B: The ratio of the DLS average particle diameter after the salt tolerance test/the DLS average particle diameter before the test is 1.2 to 1.5.
C: The ratio of the DLS average particle diameter after the salt tolerance test/the DLS average particle diameter before the test is 1.6 to 8.0.
D: The ratio of the DLS average particle diameter after the salt tolerance test/the DLS average particle diameter before the test is 8.1 to 20.0.
E: The ratio of the DLS average particle diameter after the salt tolerance test/the DLS average particle diameter before the test is 20.1 or more.

A is most preferred as the salt tolerance test results, followed by B, C, D, and E in this order.

<High-Temperature Salt Tolerance Evaluation—1>

In a hermetically sealable 120 ml Teflon® container, 65 g of the brine test sample was placed. After being hermetically sealed, the Teflon® container was left in an oven of 100° C. and kept at 100° C. for a predetermined time (720 hours). Then, the brine test sample was evaluated for its appearance, pH, electric conductivity, and DLS average particle diameter of an aqueous silica sol (silica particle) in the sample. The high-temperature salt tolerance was assessed according to the same criteria as those of “Assessment of salt tolerance” of “Room-temperature salt tolerance evaluation” described above.

<High-Temperature Salt Tolerance Evaluation—2>

The high-temperature salt tolerance was assessed by the same operation as in “High-temperature salt tolerance evaluation—1” described above except that the keeping time at 100° C. was 10 hours.

### [Preparation of Chemical Fluid for Crude Oil Recovery: Preparation of Aqueous Sol]

### Synthesis Example 1

A 2000 ml glass eggplant-shaped flask was charged with 1200 g of an aqueous silica sol (SNOWTEX® ST-O manufactured by Nissan Chemical Corp., silica concentration=20.5% by mass, BET average particle diameter: 11.0 nm, DLS average particle diameter: 17.2 nm) and a magnet stirring bar. Then, while stirred with a magnet stirrer, the flask was charged with 191.0 g of 3-glycidoxypropyltrimethoxysilane (Dynasylan GLYMO manufactured by Evonik Industries AG) such that the mass ratio of the silane compound to silica in the aqueous silica sol was 0.78. Subsequently, a cooling tube where tap water flowed was placed in the upper part of the eggplant-shaped flask. While refluxed, the aqueous sol was warmed to 60° C., kept at 60° C. for 4 hours, and then cooled. After being cooled to room temperature, the aqueous sol was taken out.

1391.0 g of an aqueous sol containing an aqueous silica sol surface-treated with a silane compound was obtained which had a mass ratio of the silane compound to silica in the aqueous silica sol=0.78, silica solid content=21.2% by mass, pH=3.1, electric conductivity=353 μS/cm, and DLS average particle diameter=23.2 nm.

### Synthesis Example 2

An aqueous sol was obtained by the same operation as in Synthesis Example 1 except that 95.5 g of 3-glycidoxypropyltrimethoxysilane (Dynasylan GLYMO manufactured by Evonik Industries AG) was added such that the mass ratio of the silane compound to silica in the aqueous silica sol (SNOWTEX® ST-O manufactured by Nissan Chemical Corp., BET average particle diameter: 11.0 nm, DLS average particle diameter: 17.2 nm) was 0.39.

1295.5 g of an aqueous sol containing an aqueous silica sol surface-treated with a silane compound was obtained which had a mass ratio of the silane compound to silica in the aqueous silica sol=0.39, silica solid content=20.9% by mass, pH=3.2, electric conductivity=363 μS/cm, and DLS average particle diameter=20.1 nm.

### Synthesis Example 3

An aqueous sol was obtained by the same operation as in Synthesis Example 1 except that 47.8 g of 3-glycidoxypropyltrimethoxysilane (Dynasylan GLYMO manufactured by Evonik Industries AG) was added such that the mass ratio of the silane compound to silica in the aqueous silica sol (SNOWTEX® ST-O manufactured by Nissan Chemical Corp., BET average particle diameter: 11.0 nm, DLS average particle diameter: 17.2 nm) was 0.20.

1247.8 g of an aqueous sol containing an aqueous silica sol surface-treated with a silane compound was obtained which had a mass ratio of the silane compound to silica in the aqueous silica sol=0.20, silica solid content=20.6% by mass, pH=2.7, electric conductivity=634 μS/cm, and DLS average particle diameter=20.0 nm.

[Preparation of Chemical Fluid for Crude Oil Recovery]

### Example 1

A stirring bar was placed in a 120 ml styrol bottle, which was then charged with 2.2 g of pure water and 87.8 g of an aqueous silica sol (SNOWTEX® ST-O manufactured by Nissan Chemical Corp., silica concentration=20.5% by mass, BET average particle diameter: 11.0 nm, DLS average particle diameter: 17.2 nm) and stirred with a magnet stirrer. Subsequently, while stirred with a magnet stirrer, the bottle was charged with 10.0 g of ascorbic acid (manufactured by Junsei Chemical Co., Ltd.), and then stirred for 1 hour to produce a chemical fluid of Example 1. The chemical fluid of Example 1 was evaluated for its pH, electric conductivity, viscosity, and DLS average particle diameter of the aqueous silica sol (silica particle) in the chemical fluid.

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 2

A stirring bar was placed in a 120 ml styrol bottle, which was then charged with 12.1 g of pure water and 84.9 g of the aqueous silica sol surface-treated with a silane compound, produced in Synthesis Example 1, and stirred with a magnet stirrer. Subsequently, while stirred with a magnet stirrer, the bottle was charged with 3.0 g of ascorbic acid (manufactured by Junsei Chemical Co., Ltd.), and then stirred for 1 hour to produce a chemical fluid of Example 2. The chemical fluid of Example 2 was evaluated for its pH, electric conductivity, viscosity, and DLS average particle diameter of the aqueous silica sol (silica particle) in the chemical fluid.

A brine test sample was prepared according to “Preparation of brine test sample” and kept at 100° C. for 30 days (720 hours) according to “High-temperature salt tolerance evaluation—1”. Then, the sample was taken out and evaluated for its high-temperature salt tolerance.

### Example 3

A stirring bar was placed in a 120 ml styrol bottle, which was then charged with 9.3 g of pure water and 84.9 g of the aqueous silica sol surface-treated with a silane compound, produced in Synthesis Example 1, and stirred with a magnet stirrer. Subsequently, while stirred with a magnet stirrer, the bottle was charged with 0.8 g of an anionic surfactant sodium α-olefinsulfonate (LIPOLAN® LB-440 manufactured by Lion Specialty Chemicals Co., Ltd., active ingredient: 36.3%), and stirred until the component was completely dissolved. Subsequently, the bottle was charged with 0.30 g of an anionic surfactant sodium dodecyl sulfate (SINOLIN® 90TK-T manufactured by New Japan Chemical Co., Ltd.) and stirred until the component was completely dissolved. Subsequently, the bottle was charged with 1.7 g of a nonionic surfactant polyoxyethylene styrenated phenyl ether of HLB=14.3 (NOIGEN® EA-157 manufactured by DKS Co., Ltd.) diluted with pure water into 70% active ingredient, and stirred until the component was completely dissolved. Subsequently, the bottle was charged with 3.0 g of ascorbic acid (manufactured by Junsei Chemical Co., Ltd.) and then stirred for 1 hour to produce a chemical fluid of Example 3. The chemical fluid of Example 3 was evaluated for its pH, electric conductivity, viscosity, and DLS average particle diameter of the aqueous silica sol (silica particle) in the chemical fluid.

A brine test sample was prepared according to “Preparation of brine test sample” and kept at 100° C. for 30 days (720 hours) according to “High-temperature salt tolerance evaluation—1”. Then, the sample was taken out and evaluated for its high-temperature salt tolerance.

### Example 4

A chemical fluid of Example 4 was produced by the same operation as in Example 2 except that the amount of ascorbic acid added was 1.0 g. The physical properties of the chemical fluid were evaluated. The amount of water added was adjusted to make the total amount 100 (100 g).

A brine test sample was prepared according to “Preparation of brine test sample” and kept at 20° C. for 3 days (72 hours) hours according to “Room-temperature salt tolerance evaluation”. Then, the sample was taken out and evaluated for its room-temperature salt tolerance.

### Example 5

A chemical fluid of Example 5 was produced by the same operation as in Example 2 except that the amount of ascorbic acid added was 5.0 g. The physical properties of the chemical fluid were evaluated. The amount of water added was adjusted to make the total amount 100 (100 g).

A brine test sample was prepared according to “Preparation of brine test sample” and kept at 100° C. for 30 days (720 hours) according to “High-temperature salt tolerance evaluation—1”. Then, the sample was taken out and evaluated for its high-temperature salt tolerance.

### Example 6

A chemical fluid of Example 6 was produced by the same operation as in Example 2 except that the amount of ascorbic acid added was 10.0 g. The physical properties of the chemical fluid were evaluated. The amount of water added was adjusted to make the total amount 100 (100 g).

A brine test sample was prepared according to “Preparation of brine test sample” and kept at 100° C. for 30 days (720 hours) according to “High-temperature salt tolerance evaluation—1”. Then, the sample was taken out and evaluated for its high-temperature salt tolerance.

### Example 7

A chemical fluid of Example 7 was produced by the same operation as in Example 2 except that the amount of ascorbic acid added was 15.0 g. The physical properties of the chemical fluid were evaluated. The amount of water added was adjusted to make the total amount 100 (100 g).

A brine test sample was prepared according to “Preparation of brine test sample” and kept at 100° C. for 30 days (720 hours) according to “High-temperature salt tolerance evaluation—1”. Then, the sample was taken out and evaluated for its high-temperature salt tolerance.

### Example 8

A chemical fluid of Example 8 was produced by the same operation as in Example 2 except that the aqueous silica sol surface-treated with a silane compound, produced in Synthesis Example 2 was added. The physical properties of the chemical fluid were evaluated. The amount of water added was adjusted to make the total amount 100 (100 g).

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 9

A chemical fluid of Example 9 was produced by the same operation as in Example 2 except that: the aqueous silica sol surface-treated with a silane compound, produced in Synthesis Example 3 was added; and the amount of ascorbic acid added was 10 g. The physical properties of the chemical fluid were evaluated. The amount of water added was adjusted to make the total amount 100 (100 g).

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 10

A chemical fluid of Example 10 was produced by the same operation as in Example 1 except that: the amount of pure water added was 66.4 g; the amount of the aqueous silica sol added was 23.6 g; and the amount of ascorbic acid added was 10.0 g. The physical properties of the chemical fluid were evaluated.

A brine test sample was prepared according to “Preparation of brine test sample” except that: the amount of the chemical fluid produced in Example 10 added was 3.0 g; and the amount of pure water added was 47.0 g. Then the sample was kept at 20° C. for 3 days (72 hours) according to “Room-temperature salt tolerance evaluation”. Then, the sample was taken out and evaluated for its room-temperature salt tolerance.

### Example 11

A stirring bar was placed in a 120 ml styrol bottle, which was then charged with 8.8 g of pure water and 84.9 g of the aqueous silica sol surface-treated with a silane compound, produced in Synthesis Example 1, and stirred with a magnet stirrer. Subsequently, while stirred with a magnet stirrer, the bottle was charged with 3.3 g of a cationic surfactant alkyl trimethylammonium chloride (CATIOGEN® TML manufactured by DKS Co., Ltd., active ingredient: 30%), and stirred until the component was completely dissolved. Subsequently, while stirred with a magnet stirrer, the bottle was charged with 3.0 g of ascorbic acid (manufactured by Junsei Chemical Co., Ltd.), and then stirred for 1 hour to produce a chemical fluid of Example 11. The chemical fluid of Example 11 was evaluated for its pH, electric conductivity, viscosity, and DLS average particle diameter of the aqueous silica sol (silica particle) in the chemical fluid.

A brine test sample was prepared according to “Preparation of brine test sample” and kept at 100° C. for 10 hours according to “High-temperature salt tolerance evaluation—2”. Then, the sample was taken out and evaluated for its high-temperature salt tolerance.

### Example 12

A chemical fluid of Example 12 was produced by the same operation as in Example 1 except that 20.0 g of gluconic acid (manufactured by FUJIFILM Wako Pure Chemical Corp., active ingredient: 50.0%) was used instead of 10.0 g of ascorbic acid (manufactured by Junsei Chemical Co., Ltd.) in Example 1 described above. The physical properties of the chemical fluid were evaluated. The amount of water added was adjusted to make the total amount 100 (100 g).

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 13

A chemical fluid of Example 13 was produced by the same operation as in Example 2 except that 6.0 g of gluconic acid (manufactured by FUJIFILM Wako Pure Chemical Corp., active ingredient: 50.0%) was used instead of 3.0 g of ascorbic acid (manufactured by Junsei Chemical Co., Ltd.) in Example 2 described above. The physical properties of the chemical fluid were evaluated. The amount of water added was adjusted to make the total amount 100 (100 g).

A brine test sample was prepared according to “Preparation of brine test sample” and kept at 100° C. for 10 hours according to “High-temperature salt tolerance evaluation—2”. Then, the sample was taken out and evaluated for its high-temperature salt tolerance.

### Example 14

A chemical fluid of Example 14 was produced by the same operation as in Example 3 except that 6.0 g of gluconic acid (manufactured by FUJIFILM Wako Pure Chemical Corp., active ingredient: 50.0%) was used instead of 3.0 g of ascorbic acid (manufactured by Junsei Chemical Co., Ltd.) in Example 3 described above. The physical properties of the chemical fluid were evaluated. The amount of water added was adjusted to make the total amount 100 (100 g).

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 15

A chemical fluid of Example 15 was produced by the same operation as in Example 1 except that 10.0 g of sodium disulfite (manufactured by Kanto Chemical Co., Inc.) was used instead of 10.0 g of ascorbic acid (manufactured by Junsei Chemical Co., Ltd.) in Example 1 described above. The physical properties of the chemical fluid were evaluated.

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Example 16

A chemical fluid of Example 16 was produced by the same operation as in Example 2 except that 3.0 g of sodium disulfite (manufactured by Kanto Chemical Co., Inc.) was used instead of 3.0 g of ascorbic acid (manufactured by Junsei Chemical Co., Ltd.) in Example 2 described above. The physical properties of the chemical fluid were evaluated.

A brine test sample was prepared according to “Preparation of brine test sample” and kept at 100° C. for 10 hours according to “High-temperature salt tolerance evaluation—2”. Then, the sample was taken out and evaluated for its high-temperature salt tolerance.

### Example 17

A chemical fluid of Example 17 was produced by the same operation as in Example 3 except that 3.0 g of sodium disulfite (manufactured by Kanto Chemical Co., Inc.) was used instead of 3.0 g of ascorbic acid (manufactured by Junsei Chemical Co., Ltd.) in Example 3 described above. The physical properties of the chemical fluid were evaluated.

A brine test sample was prepared according to “Preparation of brine test sample” and kept at 100° C. for 10 hours according to “High-temperature salt tolerance evaluation—2”. Then, the sample was taken out and evaluated for its high-temperature salt tolerance.

### Comparative Example 1

A stirring bar was placed in a 120 ml styrol bottle, which was then charged with 12.2 g of pure water and 87.8 g of an aqueous silica sol (SNOWTEX® ST-O manufactured by Nissan Chemical Corp.) and stirred with a magnet stirrer to produce a chemical fluid of Comparative Example 1. The chemical fluid of Comparative Example 1 was evaluated for its pH, electric conductivity, viscosity, and DLS average particle diameter of the aqueous silica sol (silica particle) in the chemical fluid.

A brine test sample was prepared according to “Preparation of brine test sample” and kept at 20° C. for 3 days (72 hours) according to “Room-temperature salt tolerance evaluation”. Then, the sample was taken out and evaluated for its room-temperature salt tolerance.

### Comparative Example 2

A stirring bar was placed in a 120 ml styrol bottle, which was then charged with 12.1 g of pure water and 85.1 g of the aqueous silica sol surface-treated with a silane compound, produced in Synthesis Example 1, and stirred with a magnet stirrer. Subsequently, while stirred with a magnet stirrer, the bottle was charged with 0.8 g of an anionic surfactant sodium α-olefinsulfonate (LIPOLAN® LB-440 manufactured by Lion Specialty Chemicals Co., Ltd., active ingredient: 36.3%), and stirred until the component was completely dissolved. Subsequently, the bottle was charged with 0.30 g of an anionic surfactant sodium dodecyl sulfate (SINOLIN® 90TK-T manufactured by New Japan Chemical Co., Ltd.) and stirred until the component was completely dissolved. Subsequently, the bottle was charged with 1.7 g of a nonionic surfactant polyoxyethylene styrenated phenyl ether of HLB=14.3 (NOIGEN® EA-157 manufactured by DKS Co., Ltd.) diluted with pure water into 70% active ingredient, and stirred for 1 hour to produce a chemical fluid of Comparative Example 2. The chemical fluid of Comparative Example 2 was evaluated for its pH, electric conductivity, viscosity, and DLS average particle diameter of the aqueous silica sol (silica particle) in the chemical fluid.

A brine test sample was prepared according to “Preparation of brine test sample” and kept at 100° C. for 10 hours according to “High-temperature salt tolerance evaluation—2”. Then, the sample was taken out and evaluated for its high-temperature salt tolerance.

Tables 1 to 6 show the composition (component concentrations) of the chemical fluid of each Example and the salt tolerance test results. Tables 7 and 8 show the composition (component concentrations) of the chemical fluid of each Comparative Example and the salt tolerance test results.

In the tables, the types (symbols) of the anionic surfactant, the nonionic surfactant, and the cationic surfactant are as defined below.

### <Anionic Surfactant>

AOS: Sodium α-olefin sulfonate “LIPOLAN® LB-440”, active ingredient: 36.3%, Lion Specialty Chemicals Co., Ltd.
SDS: Sodium dodecyl sulfate “SINOLIN® 90TK-T”, active ingredient: 96.0%, New Japan Chemical Co., Ltd.

### <Nonionic Surfactant>

EA-157: Polyoxyethylene styrenated phenyl ether “NOIGEN® EA-157”, active ingredient: 100%, DKS Co., Ltd.

### <Cationic Surfactant>

LTAC: Alkyl trimethylammonium chloride “CATIOGEN® TML”, active ingredient: 30%, DKS Co., Ltd.

<Interfacial Tension Evaluation>

The chemical fluid for crude oil recovery of the present invention can contain a surfactant and can therefore be expected to have a higher enhanced oil recovery effect by reducing water-oil interfacial tension in an oil reservoir and improving the substitution efficiency of oil with water.

Interfacial tension for paraffin oil was measured as to Examples 1 to 3, Examples 12 to 17, Comparative Examples 1 and 2, and seawater alone (salt concentration of 4% by mass). The measurement results are shown in Table 9.

TABLE 1

| | | Example 1 | Example 2 | Example 3 | Example 4 | Example 5 | Example 6 | Example 7 | Example 8 |
|---|---|---|---|---|---|---|---|---|---|
| Aqueous silica sol | | ST-O | Synthesis | Synthesis | Synthesis | Synthesis | Synthesis | Synthesis | Synthesis |
| | | | Example 1 | Example 1 | Example 1 | Example 1 | Example 1 | Example 1 | Example 2 |
| Amount of silane in treatment, | Mass ratio | 0 | 0.78 | 0.78 | 0.78 | 0.78 | 0.78 | 0.78 | 0.39 |
| silane/SiO₂ | | | | | | | | | |
| Silica concentration | % by mass | 18.0 | 18.0 | 18.0 | 18.0 | 18.0 | 18.0 | 18.0 | 18.0 |
| Anionic surfactant (AOS) | % by mass | 0 | 0 | 0.3 | 0 | 0 | 0 | 0 | 0 |
| concentration | | | | | | | | | |
| Anionic surfactant (SDS) | % by mass | 0 | 0 | 0.3 | 0 | 0 | 0 | 0 | 0 |
| concentration | | | | | | | | | |
| Nonionic surfactant (EA-157) | % by mass | 0 | 0 | 1.2 | 0 | 0 | 0 | 0 | 0 |
| concentration | | | | | | | | | |
| Cationic surfactant (LTAC) | % by mass | 0 | 0 | 0 | 0 | 0 | 0 | 0 | 0 |
| concentration | | | | | | | | | |
| Ascorbic acid concentration | % by mass | 10 | 3 | 3 | 1 | 5 | 10 | 15 | 3 |

TABLE 2

| | | Example 9 | Example 10 | Example 11 | Example 12 | Example 13 | Example 14 |
|---|---|---|---|---|---|---|---|
| Aqueous silica sol | | Synthesis | ST-O | Synthesis | ST-O | Synthesis | Synthesis |
| | | Example 3 | | Example 1 | | Example 1 | Example 1 |
| Amount of silane in treatment, | Mass ratio | 0.20 | 0 | 0.78 | 0 | 0.78 | 0.78 |
| silane/SiO₂ | | | | | | | |
| Silica concentration | % by mass | 18.0 | 5.0 | 18.0 | 18.0 | 18.0 | 18.0 |
| Anionic surfactant (AOS) | % by mass | 0 | 0 | 0 | 0 | 0 | 0.3 |
| concentration | | | | | | | |
| Anionic surfactant (SDS) | % by mass | 0 | 0 | 0 | 0 | 0 | 0.3 |
| concentration | | | | | | | |
| Nonionic surfactant (EA-157) | % by mass | 0 | 0 | 0 | 0 | 0 | 1.2 |
| concentration | | | | | | | |
| Cationic surfactant (LTAC) | % by mass | 0 | 0 | 1 | 0 | 0 | 0 |
| concentration | | | | | | | |
| Ascorbic acid concentration | % by mass | 10 | 10 | 3 | 0 | 0 | 0 |
| Gluconic acid concentration | % by mass | 0 | 0 | 0 | 10 | 3 | 3 |

TABLE 3

| | | Example | Example | Example |
|---|---|---|---|---|
| | | 15 | 16 | 17 |
| Aqueous silica sol | | ST-O | Synthesis | Synthesis |
| | | | Example 1 | Example 1 |
| Amount of silane in | Mass ratio | 0 | 0.78 | 0.78 |
| treatment, silane/SiO₂ | | | | |
| Silica concentration | % by mass | 18.0 | 18.0 | 18.0 |
| Anionic surfactant | % by mass | 0 | 0 | 0.3 |
| (AOS) concentration | | | | |
| Anionic surfactant | % by mass | 0 | 0 | 0.3 |
| (SDS) concentration | | | | |
| Nonionic surfactant | % by mass | 0 | 0 | 1.2 |
| (EA-157) concentration | | | | |
| Cationic surfactant | % by mass | 0 | 0 | 0 |
| (LTAC) concentration | | | | |
| Sodium disulfite | % by mass | 10 | 3 | 3 |
| concentration | | | | |

TABLE 4

| | | Example 1 | Example 2 | Example 3 | Example 4 |
|---|---|---|---|---|---|
| Physical properties of chemical fluid | | | | | |
| pH | | 2.1 | 2.5 | 2.6 | 2.8 |
| Electric conductivity | mS/cm | 1.8 | 0.77 | 1.3 | 0.57 |
| Viscosity | mPa · s | 7.5 | 8.0 | 8.5 | 7.5 |
| DLS average particle diameter | nm | 19.4 | 22.8 | 23.4 | 22.8 |
| Physical properties of salt | | | | | |
| tolerance evaluation sample | | | | | |
| Salt concentration | % by mass | 4 | 4 | 4 | 4 |
| Silica concentration | % by mass | 0.1 | 0.1 | 0.1 | 0.1 |
| pH | | 5.0 | 7.4 | 7.4 | 7.7 |
| Electric conductivity | mS/cm | 46.1 | 40.3 | 39.9 | 37.3 |
| Viscosity | mPa · s | 6.0 | 5.5 | 6.0 | 6.0 |
| DLS average particle diameter (a) | nm | 25.7 | 25.2 | 25.1 | 25.4 |
| Salt tolerance evaluation | Evaluation | Room-temperature | High-temperature | High-temperature | Room-temperature |
| | procedure | salt tolerance | salt tolerance | salt tolerance | salt tolerance |
| | | evaluation | evaluation -1 | evaluation -1 | evaluation |
| Test conditions | | 20° C. × 72 hr | 100° C. × 720 hr | 100° C. × 720 hr | 20° C. × 72 hr |
| pH | | 5.05 | 6.8 | 6.8 | 7.3 |
| Electric conductivity | mS/cm | 48.6 | 43.6 | 36.2 | 42.6 |
| DLS average particle diameter (b) | nm | 29.0 | 27.4 | 25.9 | 25.3 |
| Appearance | | Clear solution of | Clear solution of | Clear solution of | Clear solution of |
| | | colloid color | colloid color | colloid color | colloid color |

| | | | | |
|---|---|---|---|---|
| Ratio of DLS average particle diameter | 1.1 | 1.0 | 1.1 | 1.0 |
| after salt tolerance test (b)/DLS average | | | | |
| particle diameter before test (a) | | | | |
| Salt tolerance evaluation results | A | A | A | A |

| | | Example 5 | Example 6 | Example 7 | Example 8 |
|---|---|---|---|---|---|
| Physical properties of chemical fluid | | | | | |
| pH | | 2.3 | 2.1 | 2.0 | 2.4 |
| Electric conductivity | mS/cm | 0.94 | 1.09 | 1.09 | 1.07 |
| Viscosity | mPa · s | 8.5 | 9.5 | 12.0 | 7.0 |
| DLS average particle diameter | nm | 23.2 | 23.0 | 23.5 | 20.1 |
| Physical properties of salt | | | | | |
| tolerance evaluation sample | | | | | |
| Salt concentration | % by mass | 4 | 4 | 4 | 4 |
| Silica concentration | % by mass | 0.1 | 0.1 | 0.1 | 0.1 |
| pH | | 6.9 | 6.3 | 4.6 | 7.1 |
| Electric conductivity | mS/cm | 42.0 | 43.3 | 45.5 | 37.8 |
| Viscosity | mPa · s | 6.0 | 5.5 | 7.5 | 6.0 |
| DLS average particle diameter (a) | nm | 25.4 | 26.1 | 25.8 | 22.7 |
| Salt tolerance evaluation | Evaluation | High-temperature | High-temperature | High-temperature | Room-temperature |
| | procedure | salt tolerance | salt tolerance | salt tolerance | salt tolerance |
| | | evaluation -1 | evaluation -1 | evaluation -1 | evaluation |
| Test conditions | | 100° C. × 720 hr | 100° C. × 720 hr | 100° C. × 720 hr | 20° C. × 72 hr |
| pH | | 6.6 | 6.5 | 4.2 | 6.6 |
| Electric conductivity | mS/cm | 44.2 | 43.9 | 45.6 | 43.8 |
| DLS average particle diameter (b) | nm | 26.7 | 26.7 | 28.7 | 23.6 |
| Appearance | | Clear solution of | Clear solution of | Clear solution of | Clear solution of |
| | | colloid color | colloid color | pale yellow color | colloid color |

| | | | | |
|---|---|---|---|---|
| Ratio of DLS average particle diameter | 1.1 | 1.1 | 1.1 | 1.0 |
| after salt tolerance test (b)/DLS average | | | | |
| particle diameter before test (a) | | | | |
| Salt tolerance evaluation results | A | A | A | A |

TABLE 5

| | | Example 9 | Example 10 | Example 11 | Example 12 |
|---|---|---|---|---|---|
| Physical properties of chemical fluid | | | | | |
| pH | | 2.1 | 2.1 | 2.4 | 2.1 |
| Electric conductivity | mS/cm | 1.65 | 1.82 | 2.41 | 1.7 |
| Viscosity | mPa · s | 8.0 | 4.0 | 8.0 | 6.0 |
| DLS average particle diameter | nm | 20.3 | 20.4 | 24.4 | 19.5 |
| Physical properties of salt | | | | | |
| tolerance evaluation sample | | | | | |
| Salt concentration | % by mass | 4 | 4 | 4 | 4 |
| Silica concentration | % by mass | 0.1 | 0.1 | 0.1 | 0.1 |
| pH | | 5.9 | 3.6 | 7.1 | 5.0 |
| Electric conductivity | mS/cm | 40.8 | 35.4 | 37.0 | 45.1 |
| Viscosity | mPa · s | 6.0 | 6.5 | 4.0 | 5.5 |
| DLS average particle diameter (a) | nm | 23.5 | 21.2 | 23.7 | 28.0 |
| Salt tolerance evaluation | Evaluation | Room-temperature | Room-temperature | High-temperature | Room-temperature |
| | procedure | salt tolerance | salt tolerance | salt tolerance | salt tolerance |
| | | evaluation | evaluation | evaluation -2 | evaluation |
| Test conditions | | 20° C. × 72 hr | 20° C. × 72 hr | 100° C. × 10 hr | 20° C. × 72 hr |
| pH | | 5.8 | 3.5 | 6.47 | 5.1 |
| Electric conductivity | mS/cm | 43.5 | 34.5 | 33.8 | 48.6 |
| DLS average particle diameter (b) | nm | 22.7 | 21.6 | 23.1 | 29.0 |
| Appearance | | Clear solution of | Clear solution of | Clear solution of | Clear solution of |
| | | colloid color | colloid color | colloid color | colloid color |

| | | | | |
|---|---|---|---|---|
| Ratio of DLS average particle diameter | 1.0 | 1.0 | 1.0 | 1.0 |
| after salt tolerance test (b)/DLS average | | | | |
| particle diameter before test (a) | | | | |
| Salt tolerance evaluation results | A | A | A | A |

| | | Example 13 | Example 14 |
|---|---|---|---|
| Physical properties of chemical fluid | | | |
| pH | | 2.4 | 2.5 |
| Electric conductivity | mS/cm | 1.0 | 1.5 |
| Viscosity | mPa · s | 9.5 | 8.5 |
| DLS average particle diameter | nm | 23.5 | 21.7 |
| Physical properties of salt | | | |
| tolerance evaluation sample | | | |
| Salt concentration | % by mass | 4 | 4 |
| Silica concentration | % by mass | 0.1 | 0.1 |
| pH | | 7.0 | 7.2 |
| Electric conductivity | mS/cm | 43.6 | 42.5 |
| Viscosity | mPa · s | 5.0 | 6.0 |
| DLS average particle diameter (a) | nm | 25.6 | 22.9 |
| Salt tolerance evaluation | Evaluation | High-temperature | Room-temperature |
| | procedure | salt tolerance | salt tolerance |
| | | evaluation -2 | evaluation |
| Test conditions | | 100° C. × 10 hr | 20° C. × 72 hr |
| pH | | 6.8 | 7.4 |
| Electric conductivity | mS/cm | 43.2 | 45.4 |
| DLS average particle diameter (b) | nm | 27.9 | 25.3 |
| Appearance | | Clear solution of | Clear solution of |
| | | colloid color | colloid color |

| | | |
|---|---|---|
| Ratio of DLS average particle diameter | 1.1 | 1.1 |
| after salt tolerance test (b)/DLS average | | |
| particle diameter before test (a) | | |
| Salt tolerance evaluation results | A | A |

TABLE 6

| | | Example 15 | Example 16 | Example 17 |
|---|---|---|---|---|
| Physical properties of chemical fluid | | | | |
| pH | | 3.3 | 2.8 | 2.6 |
| Electric conductivity | mS/cm | 54.2 | 15.4 | 15.1 |
| Viscosity | mPa · s | 7.0 | 8.0 | 8.5 |
| DLS average particle diameter | nm | 28.0 | 23.7 | 21.8 |
| Physical properties of salt | | | | |
| tolerance evaluation sample | | | | |
| Salt concentration | % by mass | 4 | 4 | 4 |
| Silica concentration | % by mass | 0.1 | 0.1 | 0.1 |
| pH | | 3.4 | 6.7 | 6.9 |
| Electric conductivity | mS/cm | 55.3 | 43.9 | 43.4 |
| Viscosity | mPa · s | 5.0 | 5.5 | 7.0 |
| DLS average particle diameter (a) | nm | 22.3 | 25.9 | 23.5 |
| Salt tolerance evaluation | Evaluation | Room-temperature | High-temperature | High-temperature |
| | procedure | salt tolerance | salt tolerance | salt tolerance |
| | | evaluation | evaluation -2 | evaluation -2 |
| Test conditions | | 20° C. × 72 hr | 100° C. × 10 hr | 100° C. × 10 hr |
| pH | | 2.8 | 6.5 | 6.7 |
| Electric conductivity | mS/cm | 55.4 | 43.8 | 40.3 |
| DLS average particle diameter (b) | nm | 24.0 | 25.8 | 26.2 |
| Appearance | | Clear solution of | Clear solution of | Clear solution of |
| | | colloid color | colloid color | colloid color |

| | | | |
|---|---|---|---|
| Ratio of DLS average particle diameter | 1.1 | 1.1 | 1.2 |
| after salt tolerance test (b)/DLS average | | | |
| particle diameter before test (a) | | | |
| Salt tolerance evaluation results | A | A | B |

TABLE 7

| | | Comparative | Comparative |
|---|---|---|---|
| | | Example 1 | Example 2 |
| Aqueous silica sol | | ST-O | Synthesis |
| | | | Example 1 |
| Amount of silane in treatment, | Mass ratio | 0 | 0.78 |
| silane/SiO₂ | | | |
| Silica concentration | % by mass | 18.0 | 18.0 |
| Anionic surfactant (AOS) | % by mass | 0 | 0.3 |
| concentration | | | |
| Anionic surfactant (SDS) | % by mass | 0 | 0.3 |
| concentration | | | |
| Nonionic surfactant (EA-157) | % by mass | 0 | 1.2 |
| concentration | | | |
| Antioxidant concentration | % by mass | 0 | 0 |

TABLE 8

| | | Comparative | Comparative |
|---|---|---|---|
| | | Example 1 | Example 2 |
| Physical properties of chemical fluid | | | |
| pH | | 2.7 | 3.4 |
| Electric conductivity | mS/cm | 0.7 | 0.9 |
| Viscosity | mPa · s | 6.0 | 8.0 |
| DLS average particle diameter | nm | 18.9 | 23.0 |
| Physical properties of salt | | | |
| tolerance evaluation sample | | | |
| Salt concentration | % by mass | 4 | 4 |
| Silica concentration | % by mass | 0.1 | 0.1 |
| pH | | 7.7 | 7.9 |
| Electric conductivity | mS/cm | 47.2 | 48.4 |
| Viscosity | mPa · s | 5.5 | 6.0 |
| DLS average particle diameter (a) | nm | 40.2 | 22.7 |
| Salt tolerance evaluation | Evaluation | Room-temperature salt | High-temperature salt |
| | procedure | tolerance evaluation | tolerance evaluation -2 |
| Test conditions | | 20° C. × 72 hr | 100° C. × 10 hr |
| pH | | 7.9 | 6.3 |
| Electric conductivity | mS/cm | 53.4 | 48.1 |
| DLS average particle diameter (b) | nm | 1918 | 1761 |
| Appearance | | Solid-liquid separation | Solid-liquid separation |
| | | with white turbidity | with white turbidity |

| | | |
|---|---|---|
| Ratio of DLS average particle diameter | 46.4 | 76.6 |
| after salt tolerance test (b)/DLS average | | |
| particle diameter before test (a) | | |
| Salt tolerance evaluation results | E | E |

TABLE 9
Interfacial tension

| | Interfacial tension [mN/m] |
|---|---|
| Example 1 | 47.3 |
| Example 2 | 33.1 |
| Example 3 | 2.7 |
| Example 12 | 39.3 |
| Example 13 | 28.2 |
| Example 14 | 2.3 |
| Example 15 | 40.1 |
| Example 16 | 27.9 |
| Example 17 | 2.5 |
| Comparative Example 1 | 46.4 |
| Comparative Example 2 | 2.8 |
| Seawater alone | 47.3 |

As shown in Tables 4 to 6, neither layer separation nor gelation was observed in the chemical fluids of Examples 1, 4, 8 to 10, 12, 14, and 15 even after the chemical fluids were left standing at 20° C. for 72 hours in brine. As for the DLS average particle diameter of the aqueous silica sol (silica particle) in the samples, the ratio of the DLS average particle diameter after the room-temperature salt tolerance test to the DLS average particle diameter in the chemical fluid was small, and the silica sol was stable without being degenerated. Thus, these chemical fluids were confirmed to be excellent in room-temperature salt tolerance.

As shown in Tables 4 to 6, neither layer separation nor gelation was observed in the chemical fluids of Examples 2, 3, 5 to 7, 11, 13, 16, and 17 even after the chemical fluids were heated at 100° C. for 720 hours (30 days) or 10 hours in brine. As for the DLS average particle diameter of the aqueous silica sol (silica particle) in the samples, the ratio of the DLS average particle diameter after the high-temperature salt tolerance test to the DLS average particle diameter in the chemical fluid was 1.5 or less, and the silica sol was stable without being degenerated. Thus, these chemical fluids were confirmed to be excellent in high-temperature salt tolerance.

On the other hand, as shown in Tables 7 and 8, the chemical fluid of Comparative Example 1 containing no ascorbic acid and using the aqueous silica sol that was not surface-treated with a silane compound caused solid-liquid separation with white turbidity after 24 hours in “Room-temperature salt tolerance evaluation”, and resulted in very poor salt tolerance.

The chemical fluid of Comparative Example 2 containing no ascorbic acid and containing only a silane compound, two anionic surfactants, and one nonionic surfactants formed a white gel after “High-temperature salt tolerance evaluation—1”, and resulted in poor high-temperature salt tolerance.

It is believed that the chemical fluids of Examples 1 to 17 according to embodiments of the present invention improve silica dispersibility and achieve stabilization, regardless of the presence or absence of a surfactant, by blending thereinto an antioxidant such as ascorbic acid, gluconic acid, and sodium disulfite.

From these results, the chemical fluids described herein are expected to have high-performance for crude oil recovery and have excellent high-temperature salt tolerance and furthermore, excellent oil recovery rate.

As shown in Table 9, the interfacial tension was low in all of Examples 3, 14, and 17 by the effect of the added surfactant. As a result, these chemical fluids can be expected to have an enhanced oil recovery effect by reducing water-oil interfacial tension in an oil reservoir and improving the substitution efficiency of oil with water.

What is claimed is:

1. A chemical fluid for underground injection comprising an inorganic substance, an antioxidant, and water.

2. The chemical fluid for underground injection according to claim 1, wherein the inorganic substance is a colloidal particle or a powder.

3. The chemical fluid for underground injection according to claim 1, wherein the inorganic substance is at least one colloidal particle selected from the group consisting of a silica particle, an alumina particle, a titania particle, and a zirconia particle having an average particle diameter of 3 nm to 200 nm.

4. The chemical fluid for underground injection according to claim 1, wherein the inorganic substance is a silica particle in a silica sol of pH 1 to 12.

5. The chemical fluid for underground injection according to claim 1, wherein the inorganic substance is present in the chemical fluid in an amount of 0.001% by mass to 50% by mass based on a total mass of the chemical fluid.

6. The chemical fluid for underground injection according to claim 1, wherein the antioxidant is hydroxylactone, hydroxycarboxylic acid, or a salt thereof, or sulfite.

7. The chemical fluid for underground injection according to claim 1, wherein the antioxidant is ascorbic acid, gluconic acid, or a salt thereof, or bisulfite, or disulfite.

8. The chemical fluid for underground injection according to claim 1, wherein the antioxidant is present in the chemical fluid in a ratio of 0.0001 to 2 of a mass of the antioxidant to a mass of the inorganic substance.

9. The chemical fluid for underground injection according to claim 1, wherein at least a portion of a surface of the inorganic substance is coated with a silane compound including hydrolyzable silane of Formula (1):
R¹ₐSi(R²)₄₋ₐ Formula (1)
wherein each R¹ is independently an epoxycyclohexyl group, a glycidoxyalkyl group, an oxetanylalkyl ring, an organic group including any of the epoxycyclohexyl group, the glycidoxyalkyl group, or the oxetanylalkyl group, an alkyl group, an aryl group, an alkyl halide group, an aryl halide group, an alkoxyaryl group, an alkenyl group, an acyloxylalkyl group, or an organic group having an acryloyl group, a methacryloyl group, a mercapto group, an amino group, an amide group, a hydroxy group, an alkoxy group, an ester group, a sulfonyl group, or a cyano group, or a combination thereof and is bonded to the silicon atom through a Si—C bond,
R² is an alkoxy group, an acyloxy group, or a halogen atom, and
a is an integer of 1 to 3.

10. The chemical fluid for underground injection according to claim 9, wherein the silane compound is present in a ratio of 0.1 to 10.0 of a mass of the silane compound to the mass of the inorganic substance.

11. The chemical fluid for underground injection according to claim 1, further comprising an anionic surfactant, a cationic surfactant, an amphoteric surfactant, a nonionic surfactant, or a combination of two or more of these surfactants.

12. The chemical fluid for underground injection according to claim 11, wherein the surfactant is present in the chemical fluid in an amount of 0.0001% by mass to 30% by mass based on a total mass of the chemical fluid.

13. The chemical fluid for underground injection according to claim 1, wherein a ratio of DLS average particle diameter after a room-temperature salt tolerance test/DLS average particle diameter before the test is 1.5 or less (a rate of change in average particle diameter is 50% or less), wherein the room-temperature salt tolerance test stores the chemical fluid at 20° C. for 72 hours with a concentration of the inorganic substance set to a concentration of 0.1% by mass in an environment having a salt concentration of 4% by mass.

14. The chemical fluid for underground injection according to claim 1, wherein a ratio of DLS average particle diameter after a high-temperature salt tolerance test/DLS average particle diameter before the test is 1.5 or less (a rate of change in average particle diameter is 50% or less), wherein the high-temperature salt tolerance test stores the chemical fluid at 100° C. for 720 hours with a concentration of the inorganic substance set to a concentration of 0.1% by mass in an environment having a salt concentration of 4% by mass.

15. The chemical fluid for underground injection according to claim 1, wherein the chemical fluid is suitable for crude oil recovery which is used for recovering crude oil from an underground hydrocarbon-containing reservoir and pumped into an underground reservoir from an injection well to recover the crude oil from a production well.

16. The chemical fluid for underground injection according to claim 15, wherein the chemical fluid for underground injection is a chemical fluid for crude oil recovery containing 0.1% by mass to 35% by mass of a salt based on a total mass of the chemical fluid.

17. The chemical fluid for underground injection according to claim 1, further comprising: at least one selected from the group consisting of hydroxyethylcellulose, a salt thereof, hydroxypropylmethylcellulose, a salt thereof, carboxymethylcellulose, a salt thereof, pectin, guar gum, xanthan gum, tamarind gum, carrageenan, polyacrylamides, and derivatives thereof.

18. A method for recovering crude oil from an underground hydrocarbon-containing reservoir, the method comprising the steps of:
(a) injecting the chemical fluid for underground injection according to claim 1 into an underground reservoir from an injection well; and
(b) recovering crude oil from a production well, together with the chemical fluid injected into the underground reservoir.
